(19) United States
(12) Patent Application Publication
(10) Pub. No.: US 2025/0202204 A1
(43) Pub. Date: Jun. 19, 2025

(54) METHOD FOR INSTALLING CABLES WITHIN A CABLE BUS MANAGEMENT BLOCK

(71) Applicant: Cablofil, Inc., Mascoutah, IL (US)

(72) Inventors: Dallas KELLERMAN, Belleville, IL (US); Robert CRAIN, Caseyville, IL (US)

(21) Appl. No.: 18/786,907

(22) Filed: Jul. 29, 2024

Related U.S. Application Data
(63) Continuation-in-part of application No. 18/543,016, filed on Dec. 18, 2023.

(51) Int. Cl. H02G 1/06; H01R 4/36

(52) U.S. Cl. CPC H02G 1/06; H01R 4/36

(57) ABSTRACT

A cable bus management block for retaining cables having a housing with a base and two opposing sidewalls extending upward generally perpendicular to the base, and a set of channel rungs attached to the sidewalls and extending upward perpendicular to the base, where each of the channel rungs includes a channel along its length. A cable block spacer assembly sits within the channels of the channel rungs, wherein the cable block spacer assembly has a plurality of apertures through which the cables may be retained. The cable bus management block further includes an upper channel support having a channel for seating on top of the cable block spacer assembly, with a securement bar extending laterally across the cable bus management block between the sidewalls, with the securement bar attached to the channel rungs to hold the cable block spacer assembly in place.

### CROSS REFERENCE TO RELATED APPLICATION

This application is a continuation-in-part of U.S. patent application Ser. No. 18/543,016, filed on Dec. 18, 2023, the contents of which is incorporated herein by reference in its entirety.

### FIELD OF THE DISCLOSURE

The present disclosure generally relates to systems to contain and manage electrical power cables, data transmission lines, and the like. More particularly, the disclosure relates to cable bus support blocks that aid in routing and supporting cables.

### BACKGROUND

Cable trays and similar systems are used to support cables and the like which run within buildings such as factories and other industrial sites. One form of a cable tray is a cable bus management block that aids in supporting and routing different forms of cables, including electrical power cables. The cable bus management blocks often include a plurality of stacked support blocks having passages for receiving and retaining cables. In conventional cable bus management blocks, each support block has holes for receiving a bolt or rod to retain the support blocks in place within the cable bus management block. Other forms of cable bus management blocks often require bolts extending into or through the cable block spacers, either vertically or horizontally, which leads to enhanced labor costs and increased installation complexity as the through holes for the bolts or rods must be properly aligned.

Therefore, it is desirable to have a cable bus management block that can readily accommodate support blocks retained therein without the installation complexity of prior art management blocks.

### SUMMARY OF THE DISCLOSURE

Among the various aspects of the present invention is the provision of a cable bus management block as substantially shown and described.

One aspect of the disclosure is directed to a cable bus management block that includes a housing having a base and two opposing sidewalls extending upward generally perpendicular to the base. A set of channel rungs is attached to the sidewalls and extends upward perpendicular to the base, with each of the channel rungs having a channel along its length for securing a cable block spacer assembly seated within the channels of the channel rungs. The cable block spacer assembly has a plurality of passages or apertures through which the cables may be retained. In lieu of securing the cable block spacers of the cable block spacer assembly to each other, a securement bar may be placed above the cable block spacer assembly extending laterally across the cable bus management block between the sidewalls, where the securement bar is attached to the channel rungs and holds the cable block spacer assembly in place.

Preferably, the cable bus management block may also include a lower channel support extending laterally across the cable bus management block between the sidewalls and adjacent the base, such that the cable block spacer assembly sits within the lower channel support. In addition, the cable bus management block may have an upper channel support having a channel for seating on top of the cable block spacer assembly and below the securement bar.

Another aspect is directed to a method of installing cables within a cable bus management block that includes a housing having a base and two opposing sidewalls extending generally perpendicular to the base, a set of channel rungs attached to the sidewalls and extending perpendicular to the base, wherein each of the channel rungs includes a channel along its length, and a cable block spacer assembly seated within the channels of the channel rungs, wherein the cable block spacer assembly has a plurality of sets of apertures through which the cables may be retained. Preferably, this method includes the steps of placing a bottom cable block spacer having a first set of cutouts on its top surface into the set of channel rungs, installing a first set of cables in the first set of cutouts of the bottom cable block spacer, placing an intermediate cable block spacer having third and fourth sets of cutouts on its top and bottom surfaces into the set of channel rungs, wherein the first set of cutouts of the bottom cable block spacer align with the fourth set of cutouts of the intermediate cable block spacer forming a first set of apertures of the cable block cable assembly, such that the first set of cables is located in the first set of apertures, temporarily clamping the intermediate cable block spacer in place in the channel rungs, installing a second set of cables in the third set of cutouts of the intermediate cable block spacer, placing a top cable block spacer having a second set of cutouts on its bottom surface into the channel rungs, wherein the second set of cutouts of the top cable block spacer align with the third set of cutouts of the intermediate cable block spacer forming a second set of apertures, such that the second set of cables is located in the second set of apertures of the cable block spacer assembly, unclamping the intermediate cable block spacers, and placing a securement bar above the cable block spacer assembly extending laterally across the cable bus management block between the sidewalls, wherein the securement bar is attached to the channel rungs and holds the cable block spacer assembly in place.

Yet another aspect is directed to a lay-in style grounding lug having a first side portion with a first cap receiving channel comprising a top surface and a bottom surface, where the top surface may be angled downwardly toward a concave cable receiving channel. The first side portion includes an aperture for receiving a fastener to mount the grounding lug. Together with the first side portion, a second side portion also having a second cap receiving channel partially defines a concave cable receiving channel formed between the first and second side portions. The grounding lug also includes a securement cap configured to slide into the first and second cap receiving channels.

### BRIEF DESCRIPTION OF THE DRAWINGS

These and other features, aspects and advantages of the disclosure will become more fully apparent from the following detailed description, appended claims, and accompanying drawings, wherein the drawings illustrate features in accordance with exemplary aspects of the disclosure, and wherein:

FIG. 1 is a perspective view of a cable bus management block;

FIG. 2 is a front view of the cable bus management block;

FIG. 3 is perspective view of certain components of the cable bus management block;

FIG. 4 is a front view of certain components of the cable bus management block;

FIG. 5 is a perspective view of the components of the cable bus management block shown in FIG. 4;

FIG. 6 is a perspective view of a retainer shown in an unclamped position;

FIG. 7 is a perspective view of a retainer shown in a clamped position;

FIG. 8 illustrates the retainer of FIGS. 6 and 7 installed within a cable bus management block;

FIG. 9 is another illustration of the retainer of FIGS. 6 and 7 installed within a cable bus management block;

FIG. 10 is a perspective view of a grounding lug according to one embodiment;

FIG. 11 illustrates the grounding lug of FIG. 10 installed within a cable bus management block;

FIG. 12 is a side view of a grounding lug in accordance with another embodiment;

FIG. 13 illustrates the grounding lug of FIG. 12 installed within a cable bus management block;

FIG. 14 is a side view of another embodiment of a grounding lug as installed in a cable bus management block; and

FIG. 15 is a perspective view of a grounding lug according to another embodiment.

### DETAILED DESCRIPTION

The accompanying Figures and this description depict and describe embodiments of a cable bus management block in accordance with the present disclosure, and features and components thereof. It should also be noted that any references herein to front and back, right and left, top and bottom, upper and lower, and first and second are intended for convenience of description, not to limit the present invention or its components to any one positional or spatial orientation.

Before any aspects of the disclosure are explained in detail, it will be understood that the disclosure is not limited in its application to the details of construction and the arrangement of components set forth in the following description or illustrated in the figures. The disclosure is capable of other aspects and of being practiced or of being carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. All numbers expressing measurements and so forth used in the specification and claims are to be understood as being modified in all instances by the term “about.”

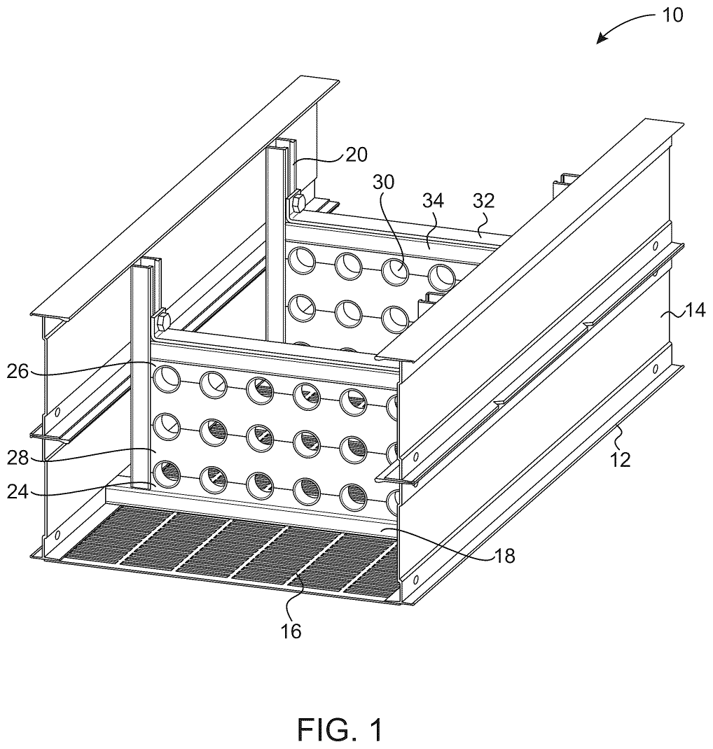

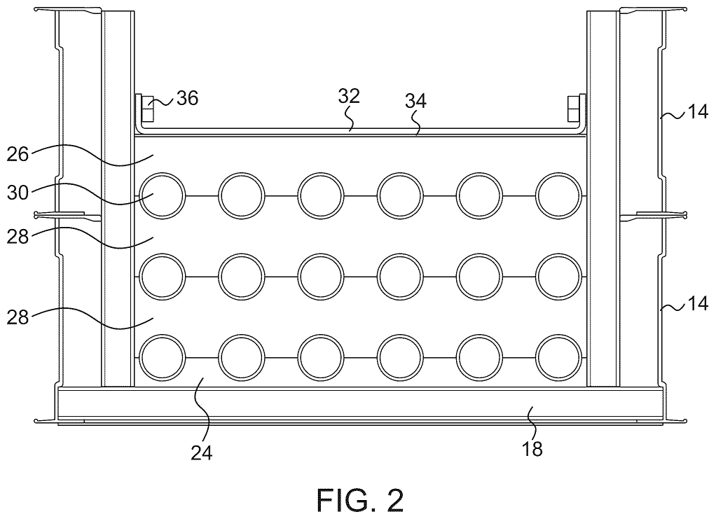

With initial reference to FIGS. 1 and 2, a cable bus management block 10 includes housing 12 that includes a base portion 16 and at least two sidewalls 14 extending upward generally perpendicular to the base portion 16. The sidewalls 14 and base portion 16 of the housing 12 may be made of aluminum, steel, or other metals or suitable plastics. Depending on the application, the housing 12 may include more than one set of sidewalls 14 to increase the overall height of the cable bus management block 10 in order to retain additional cables. The housing 12 may be assembled together via welding, soldering, gluing, or bolting the sidewalls 14 to the base portion 16. The cable bus management block 10 also includes a lower channel support 18 having an upwardly facing channel. The cable bus management block 10 further includes a set of channel rungs 20 attached to the sidewalls and extending upward perpendicular to the base, wherein each of the channel rungs 20 includes a channel.

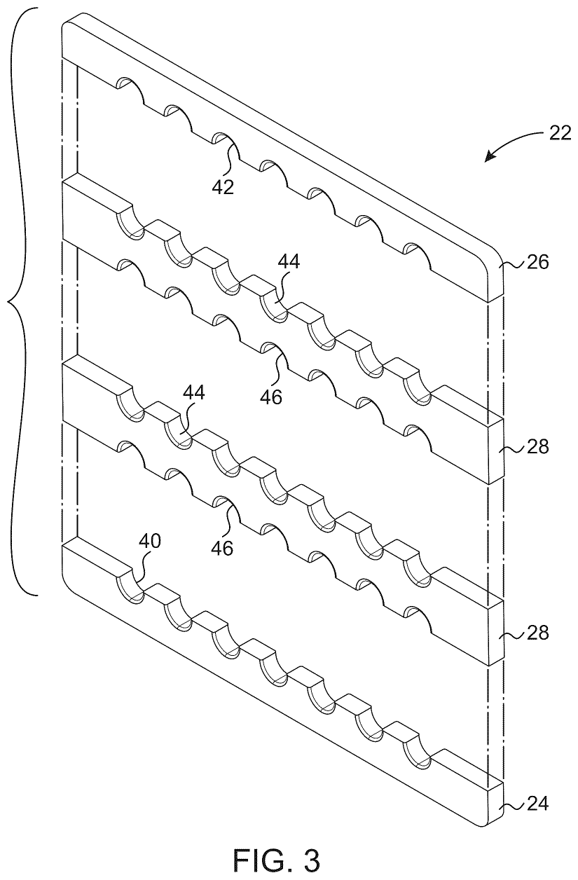

The cable bus management block 10 includes a cable block spacer assembly 22 seated within the channel rungs 20 and the lower channel support 18. The cable block spacer assembly 22 includes apertures 30 for receiving and retaining the cables. The assembly 22 includes a bottom cable block spacer 24, one or more intermediate cable block spacers 28 and a top cable block spacer 26. Preferably, the intermediate cable block spacers 28 are identical to one another. Each of the cable block spacers 24, 26, 28 include cutouts on their top and/or bottom surfaces as shown in FIG. 3. For example, the bottom cable block spacer 24 may have a first set of cutouts 40 on its top surface, the top cable block spacer 26 may have a second set of cutouts 42 on its bottom surface, and the intermediate cable block spacers 28 may have third and fourth sets of cutouts 44, 46 on their top and bottom surfaces. Preferably, the first set of cutouts 40 of the bottom cable block spacer 24 align with the fourth set of cutouts 46 of the intermediate cable block spacer 28 adjacent the bottom cable block spacer 24 and the second set of cutouts 42 of the top cable block spacer 26 align with the third set of cutouts 44 of the intermediate cable block spacer adjacent the top cable block spacer 26. The cutouts 40, 42, 44, and 46 may be of similar shape such as semi-circular as shown in the figures.

The bottom cable block spacer 24 is seated within the channel of the lower channel support 18. The cable block spacers 24, 26, 28 are assembled together by stacking on top of each other such that the cutouts 40, 42, 44, 46 form the apertures 30. During assembly, the cables are seated within the cutouts of a lower cable block spacer prior to installing the next tier of cable block spacers. The sides of each of the cable block spacers 24, 26, 28 are retained within slots of the channel rungs 20 by sliding the cable block spacers into the channel of the rungs 20. In one embodiment, the sides of the cable spacer blocks 24, 26, 28 may narrow in width or depth in the region that slides into the channel rungs 20. The cable spacer blocks 24, 26, 28 may be formed from any suitable material such as high density polyethylene.

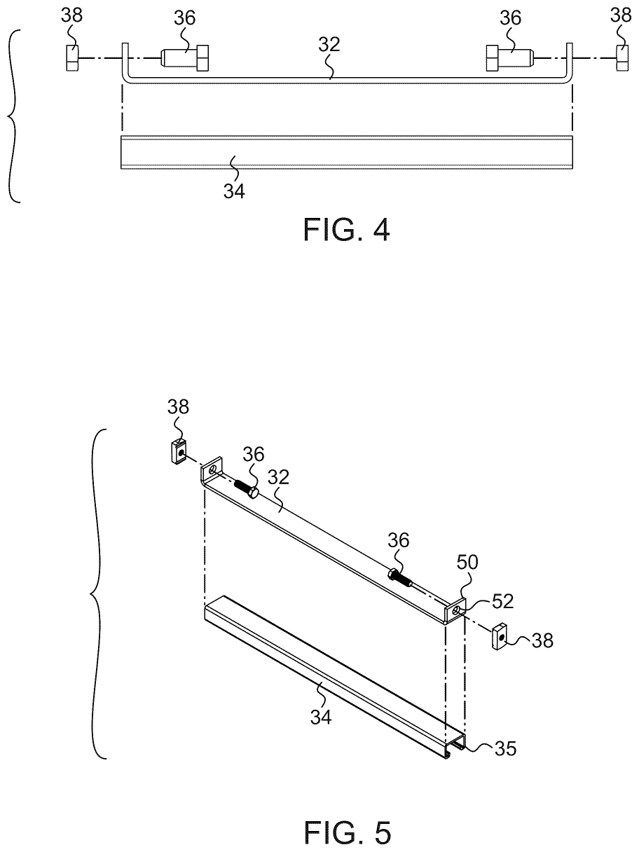

As shown in FIGS. 4 and 5, the cable bus management block 10 includes an upper channel support 34 extending between the sidewalls 14 having a channel 35 for seating on top of the cable block spacer assembly, for example, on top of the top cable block spacer 26. A securement bar 32 sits on top of the upper channel support 34. As shown in FIG. 5, each end of the securement bar 32 preferably includes an upwardly-turned portion 50 having an opening 52 permitting the securement bar 32 to be attached to the channel rungs 20 with fasteners passing through the opening. For example, the fasteners may include a bolt 36 having a head and a threaded shank, wherein the head of the bolt 36 is slotted within the channel rungs 20, the shank of the bolt extends through the opening 52 of the securement bar 32, and a nut 38 threaded onto the shank of the bolt 36. Alternatively, the nut 38 may be slotted within the channel rungs 20 and the shank of the bolt 36 passes through the opening 52 of the securement bar 32 and threaded within the nut 38 to retain the securement bar 32 in place, thus securing the cable spacer blocks 24, 26, 28 in place within the cable bus management block 10. In this alternative embodiment, the nut 38 may be square-shaped to engage with the channel of the channel rungs 20 such that the nut 38 stays in place as the bolt 36 is threaded therethrough.

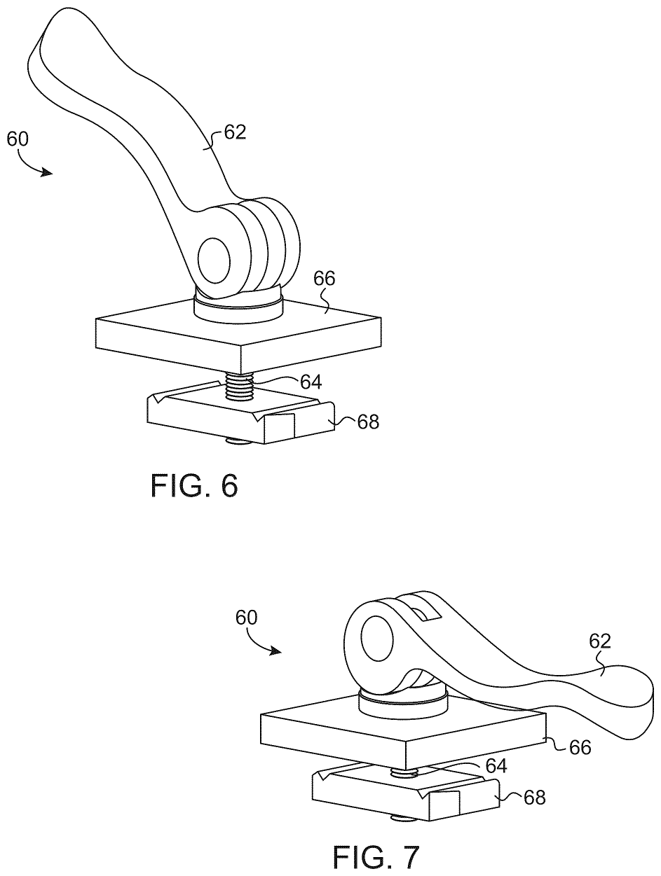

In yet another embodiment, which may be particularly useful in applications where the cable bus management block 10 is installed in a vertical orientation, includes a method of installing cables within a cable bus management block 10. As illustrated in FIGS. 6 and 7, this embodiment may include the use of a retainer 60 shown in an unclamped position in FIG. 6, while and FIG. 7 illustrates the retainer 60 in a clamped position. In this embodiment, the retainer 60 includes a clamping handle 62 threaded onto a threaded stud 64, a washer 66, and a channel nut 68.

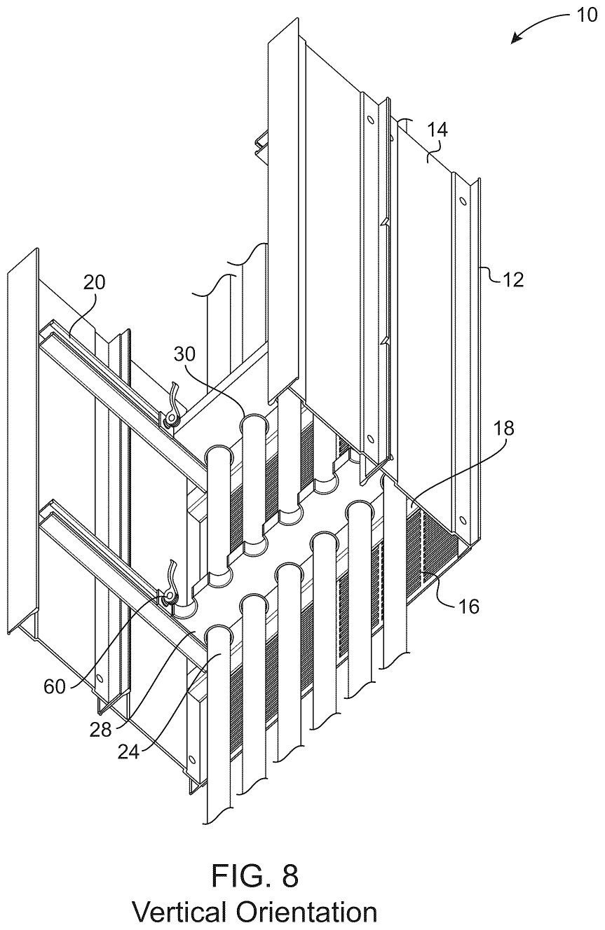

Referring to FIG. 8, in use, with the cable bus management block 10 in a vertical orientation, one or more bottom cable block spacers 24 are seated within the channel of lower channel supports 18. A first set of cables is placed within one or more of the of the first set of cutouts 40 and then intermediate cable block spacers 28 are placed over the bottom cable block spacers 24. The channel nut 68 of a retainer 60 in its unclamped position is slid into the open channel 26 of each of the four channel rungs 20 down until it engages with the intermediate cable block spacers 28. The retainer 60 is then moved into its clamped position by pushing down on the clamping handle 62, which then brings the washer 66 and the channel nut 68 closer together along the length of the threaded stud 64. When the retainer 60 is in its clamped position, the retainer is held in place against the channel rung 20 with the edge of the washer pressed against the intermediate cable block spacer 28, thus retaining the intermediate cable block spacer 28 and the cables placed between the intermediate cable block spacer 28 and the bottom cable block spacers 24 in place.

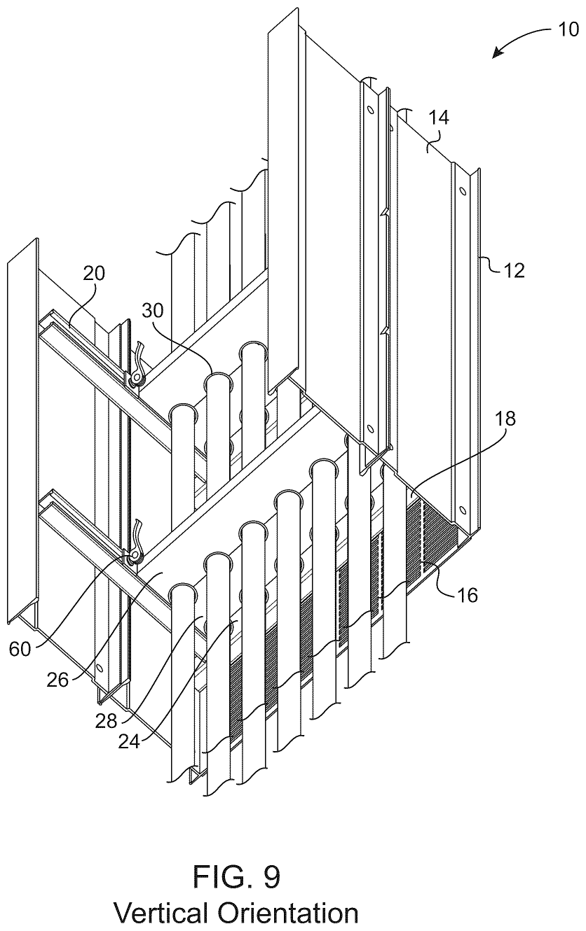

As illustrated in FIG. 9, for applications requiring installation of multiple rows of cables in a cable bus management block 10 in a vertical orientation, a top cable block spacer 26 (or a second intermediate cable block spacer 28) may be installed in the channels of the channel rungs 20. Another set of cables may then be placed within the apertures 30 formed between the first and second intermediate cable block spacers 28 or between intermediate cable block spacer 28 and the top cable block spacer 26. Another set of retainers 60 are then placed into the open channels of each channel rung 20 and moved into a clamped position. When all of the rows of cables are installed, the retainers may be removed and a securement bar 32 may be installed above the cable block spacer assembly 22 extending laterally across the cable bus management block 10 between the sidewalls 14, wherein the securement bar 32 may be attached to the channel rungs 20 to hold the cable block spacer assembly 22 in place.

Although this method has been illustrated using the retain 60 illustrated in FIGS. 6 and 7, alternative locking mechanisms such as a knob, or other types of cam handles or latches fall within the spirit of the invention.

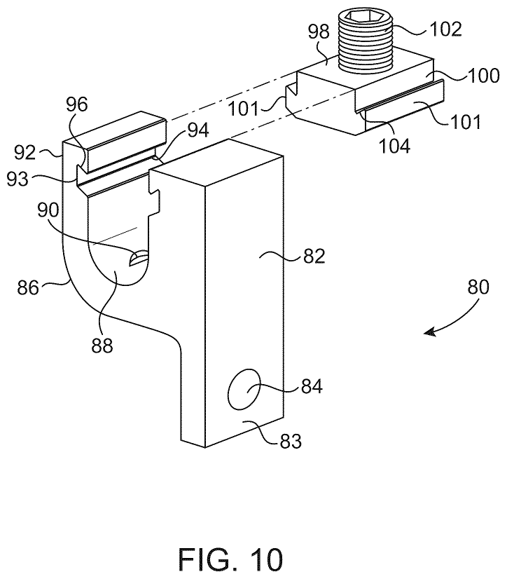

In another embodiment, a lay-in style grounding lug 80 as illustrated in FIG. 10 may be installed in the cable bus management block for use in securing a grounding cable. The embodiment of a grounding lug 80 illustrated in FIG. 10 includes an open ground wire passage partially defined by a concave cable receiving channel 88 formed between first and second side portions 82 and 92. The first side portion 82 preferably includes a lower flange 83 extending below the bottom of the concave channel 88 and has an aperture 84 for receiving a fastener (not shown) to mount the grounding lug 80 to one of the sidewalls 14 of the cable bus management block 10. First side portion 82 may be generally planar on its exterior side while second side 92 may include a rounded portion 86 aiding in forming the channel 88. The interior of the concave channel 88 may include one or more indentations 90 that may partially pierce the ground cable to aid in holding the ground cable in place as the ground cable is secured within the channel 88.

The interior side of the first and second portions 82 and 92 include cap receiving channels 93 on each side. As illustrated in FIG. 10, these cap receiving channels 93 may include a top surface 96 and a bottom surface 94. Preferably the top surface 96 of each cap receiving channel 93 is angled downwardly toward the concave cable receiving channel 88. The bottom surface 94 may also be angled either upwardly away from the concave cable receiving channel 88 or, as shown in FIG. 10, downwardly toward the concave cable receiving channel 88.

The grounding lug 80 further includes a securement cap 98 designed to slide into the cap receiving channels 93. The cap 98 has flanges 101 on each side extending outwardly from the main body 100 of the cap 98. The flanges have a top surface 104 and a bottom surface designed to mate with the top surface 96 and the bottom surface 94 of the cap receiving channels 93, aiding in securing the cap 98 in place when the cap 98 is slid into the cap receiving channel 93. The top surface 104 is thus angled upwardly at an angle that is approximately the same the angle that the top surface 96 is angled downwardly. The securement cap 98 further includes a clamp screw 102 threadedly received through the cap 98 to engage with and secure a grounding cable firmly in place in the cable receiving channel 88.

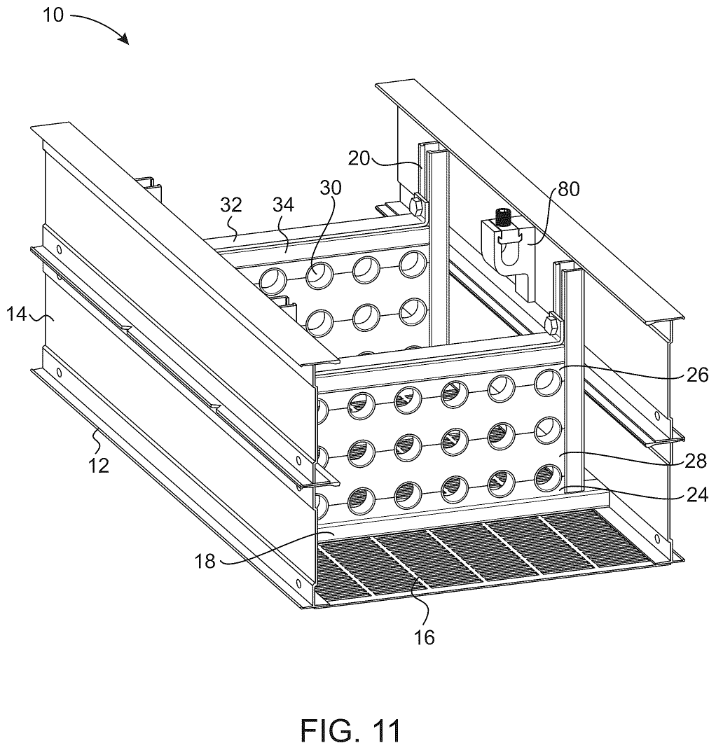

FIG. 11 illustrates the grounding lug 80 mounted in the interior of cable bus management block 10.

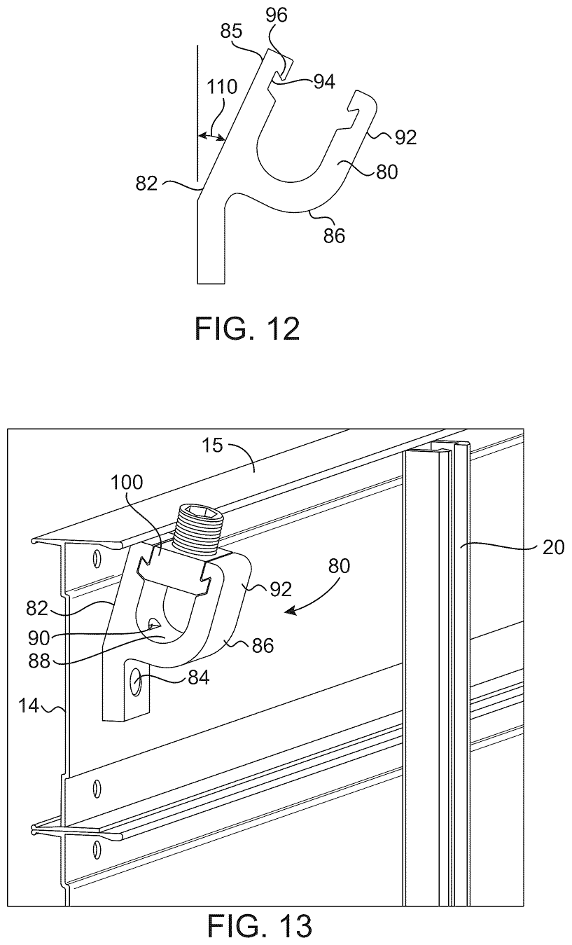

FIG. 12 illustrates an alternative embodiment of the grounding lug 80 having an angled lower flange 83. In one embodiment, the lower flange 83 may be angled from an upper portion 85 of the first side portion 82 by about 25 degrees. As illustrated in FIG. 13, when the grounding lug 80 illustrated in FIG. 12 is mounted into a cable bus management block 10, access to the clamp screw 98 is enhanced, particularly in installations as shown in FIG. 13 in which the sidewalls 14 of the cable bus management block 10 include a top portion 15.

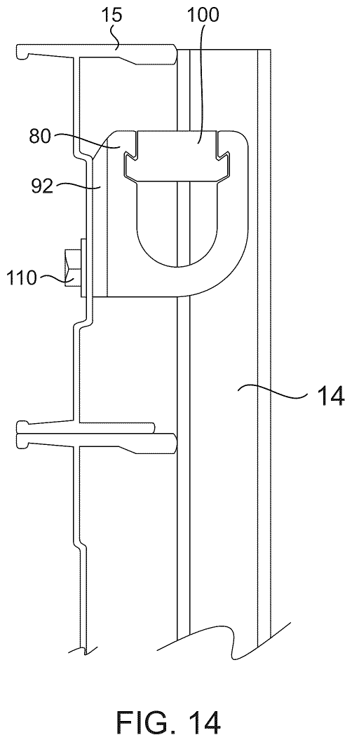

FIG. 14 illustrates another embodiment of the grounding lug 80. In this embodiment, the first side portion 82 lacks a lower flange 83. Instead, the upper portion 85 of the first side portion 82 includes an aperture for receiving a bolt 110 to secure the grounding lug 80 to one of the sidewalls 14 of the cable bus management block 10. The bolt 110 may be located as shown in FIG. 14, or in another location adjacent to the second side portion 92.

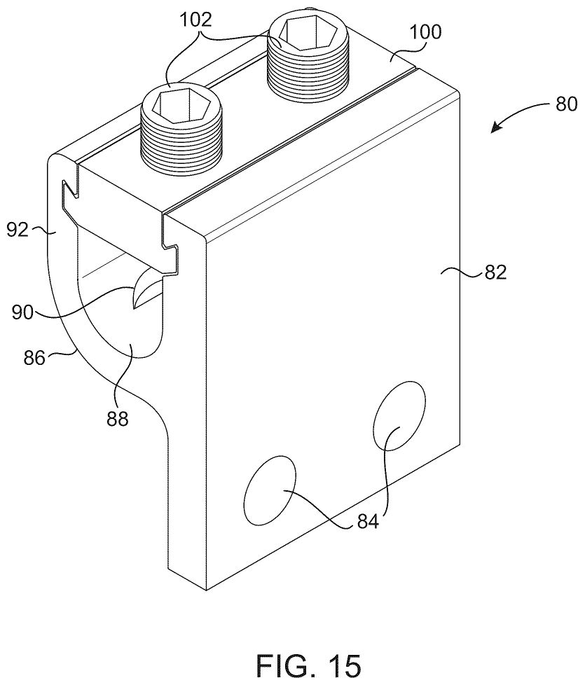

Those in the art will appreciate that the grounding lug 80 may be longer than shown in FIG. 10. For example, FIG. 15 illustrates an embodiment of the grounding lug 80 that is double the length and, therefore, may include two apertures 84 for installation and may include a longer main body 100 of the cap 98 having more than one clamp screws 102. Other similar embodiments are within the scope of the invention.

As those skilled in the art will appreciate, modifications and variations are possible without departing the scope of the invention defined in the appended claims. Furthermore, it should be appreciated that all examples in the present disclosure are provided as non-limiting examples.

What is claimed is:

1. A method of installing cables within a cable bus management block, wherein the cable bus management block comprises:
a housing having a base and two opposing sidewalls extending generally perpendicular to the base;
a set of channel rungs attached to the sidewalls and extending perpendicular to the base, wherein each of the channel rungs includes a channel along its length; and
a cable block spacer assembly seated within the channels of the channel rungs, wherein the cable block spacer assembly has a plurality of sets of apertures through which the cables may be retained;
the method comprising the steps of:
placing a bottom cable block spacer having a first set of cutouts on its top surface into the set of channel rungs;
installing a first set of cables in the first set of cutouts of the bottom cable block spacer;
placing an intermediate cable block spacer having third and fourth sets of cutouts on its top and bottom surfaces into the set of channel rungs, wherein the first set of cutouts of the bottom cable block spacer align with the fourth set of cutouts of the intermediate cable block spacer forming a first set of apertures of the cable block cable assembly, such that the first set of cables is located in the first set of apertures;
temporarily clamping the intermediate cable block spacer in place in the channel rungs;
installing a second set of cables in the third set of cutouts of the intermediate cable block spacer;
placing a top cable block spacer having a second set of cutouts on its bottom surface into the channel rungs, wherein the second set of cutouts of the top cable block spacer align with the third set of cutouts of the intermediate cable block spacer forming a second set of apertures, such that the second set of cables is located in the second set of apertures of the cable block spacer assembly;
unclamping the intermediate cable block spacers; and
placing a securement bar above the cable block spacer assembly extending laterally across the cable bus management block between the sidewalls, wherein the securement bar is attached to the channel rungs and holds the cable block spacer assembly in place.

2. The method of claim 2 further comprising the step of temporarily clamping the top cable block spacer in place in the channel rungs.

3. The method of claim 1 further comprising the step of installing a lower channel support extending laterally across the cable bus management block between the sidewalls and adjacent the base, wherein the cable block spacer assembly seats within the lower channel support.

4. The method of claim 3 wherein the bottom cable block spacer is seated within the channel of the lower channel support.

5. The method of claim 1 further comprising the step of installing an upper channel support having a channel for seating on top of the cable block spacer assembly and below the securement bar.

6. The method of claim 1 wherein the step of temporarily clamping the intermediate cable block spacer in place in the channel rungs comprises the step of placing a retainer into each of the channels of the channel rung and moving the retainers into a clamped position.

7. A lay-in style grounding lug comprising:
a first side portion comprising a first cap receiving channel having a top surface and a bottom surface, wherein the top surface is angled downwardly;
a second side portion comprising a second cap receiving channel having a top surface and a bottom surface;
an open ground cable passage partially defined by a concave cable receiving channel formed between the first and second side portions; and
a securement cap configured to slide into the first and second cap receiving channels;
wherein the first side portion comprises a lower flange extending below the concave channel and wherein the flange has an aperture for receiving a fastener to mount the grounding lug.

8. The grounding lug of claim 7 further comprising at least one indentation located in the concave channel that may partially pierce a ground cable to aid in holding the ground cable in place as the ground cable is secured within the channel.

9. The grounding lug of claim 7 wherein the securement cap comprises flanges on opposing sides of the cap and extending outwardly therefrom.

10. The grounding lug of claim 9 wherein the flanges have a top surface and a bottom surface configured to mate with the top surface and bottom surface of the first and second cap receiving channels to aid in securing the cap in place when the cap is slid into the cap receiving channel.

11. The grounding lug of claim 10 wherein the top surfaces of the flanges are angled upwardly at an angle that is approximately the same the angle that the top surfaces of the first and second cap receiving channels are angled downwardly.

12. The grounding lug of claim 7 wherein the securement cap further comprises a clamp screw configured to extend through an aperture in the securement cap to secure a grounding cable firmly in place in the cable receiving channel.

13. The grounding lug of claim 7 wherein the first side portion comprises an upper portion and wherein the flange is angled away from the upper portion of the first side.

14. A lay-in style grounding lug comprising:
a first side portion comprising a first cap receiving channel having a top surface and a bottom surface wherein the top surface is angled downwardly;
a second side portion comprising a second cap receiving channel having a top surface and a bottom surface;
an open ground cable passage partially defined by a concave cable receiving channel formed between the first and second side portions; and
a securement cap configured to slide into the first and second cap receiving channels;
wherein the first side portion comprises an aperture for receiving a fastener to mount the grounding lug.
